(19) United States
(12) Patent Application Publication
(10) Pub. No.: US 2008/0186206 A1
(43) Pub. Date: Aug. 7, 2008

(54) Communication Device and Communication System as Well as Method of Communication Between and Among Mobile Nodes Such as Vehicles

(75) Inventor: Hans-Jurgen Reumerman, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,744

(22) PCT Filed: Dec. 19, 2005
(86) PCT No.: PCT/IB05/54303

§ 371 Date: Jun. 25, 2007

(30) Foreign Application Priority Data
Jan. 7, 2005 (EP) 05100071.9

(51) Int. Cl. G08G 1/00

(52) U.S. Cl. 340/902

(57) ABSTRACT

In order to provide a communication device (100) for communication between and among mobile nodes (10, 12, 14, 16) comprising at least one transmission unit (20) for communicating at least one message (22),—at least one receiver unit (30) for sensing at least one arriving message (32, 34, 36) being communicated by at least one neighbouring node (12, 14, 16), and at least one localisation unit (60) for determining and/or for monitoring the moving direction and/or the current position of the respective node (10, 12, 14, 16), wherein the amount of broadcast messages in inter-node communication, in particular in inter-vehicle communication, is reduced, it is proposed that each message (22; 32, 34, 36) being communicated between and among the nodes (10, 12, 14, 16) is assigned to at least one message type and/or message subject and - to at least one direction area relating to the moving direction of the node (10, 12, 14, 16) by which the respective message (22; 32, 34, 36) is transmitted, the moving direction being determined and/or monitored by the localisation unit (60) of the respective node (10, 12, 14, 16).

The present invention relates to a communication device for as well as to a method of communication between and among mobile nodes, in particular between and among vehicles, with each node being designed for
determining and/or monitoring the moving direction and/or the current position of the respective node
sensing at least one arriving message being communicated, in particular broadcasted and/or rebroadcasted, by at least one neighbouring node, and
communicating, in particular broadcasting and/or rebroadcasting, at least one message.

The prior art article “A Multicast Protocol in Ad hoc Networks Inter-Vehicle Geocast” by Abdelmalik Bachir and Abderrahim Benslimane [Proceedings of 58th IEEE Vehicular Technology Conference, fall 2003, volume 57, issue 4, pages 2456 to 2460] is directly related to the technical field as defined above and summarizes the state of the art, combining existing algorithms to become the so-called I[nter-]V[ehicle]G[eocast] algorithm and coping with the low penetration ratio problem.

The scenario discussed by Bachir and Benslimane in this article is restricted to a unidirectional straight road, for example to a highway, where the critical area is in the driving direction of the reference vehicles and in case of a danger all vehicles behind the reference vehicles have to be warned.

The I[nter-]V[ehicle]G[eocast] algorithm is based on rebroadcasting messages by a so-called “relay”. The article by Bachir and Benslimane focuses on the timing constraints for rebroadcasting and defines the so-called “defer time” controlled by a dedicated timer, depending on the calculated distance to the message originator.

According to the article by Bachir and Benslimane, for each received message the vehicle has to determine its location in relation to the message originator, for example to a broken vehicle, and has to define if a received message is relevant. The received message is relevant if the vehicle is cruising towards the critical area and if the message is received for the first time.

When a vehicle receives the same alarm message before its defer timer expires, it concludes that there is another vehicle behind it which is broadcasting the same alarm message. In this situation, the second alarm message is not relevant because the vehicle was already informed about the accident by the first alarm message. Moreover, in this situation it is useless to rebroadcast the second alarm message because there is a relay ensuring the alarm dissemination of the second alarm message behind the vehicle.

Moreover, according to the article by Bachir and Benslimane if no identical message can be received after the defer timer has expired, the node considers itself to be the last node informed, and starts repeating the message. The defer time concept ensures that nodes having a larger distance from the originator are the first to start rebroadcasting the alarm message.

In case another vehicle behind the relay vehicle receives the alarm message the other vehicle will execute the defer time algorithm and when its timer expires the other vehicle rebroadcasts this alarm message. At this time, the relay node receives the same alarm message and stops its periodic broadcast since the other vehicle will resume the role of the relay station.

The method according to the article by Bachir and Benslimane uses as information
the known G[lobal]P[ositioning]S[ystem] position of the vehicles and
the direction of the vehicles.

However, the applicability of the I[nter-]V[ehicle]G[eocast] concept is restricted to unidirectional road topologies and assumes that the danger is always “ahead” of the road since the IVG concept interprets reception of an identical message from another node as being a kind of acknowledgement.

Apart from that prior art document US 2004/0083035 A1 mentions a warning message system for collision avoidance based on broadcast transmitters and receivers installed in each vehicle and using a dedicated emergency frequency. However, the network functions for broadcasting and acknowledgement of messages are out of scope.

Prior art document US 6 720 920 B2 discloses a method and an arrangement for communicating between vehicles wherein it is proposed
to check the relevance of messages based on GPS position and available map data,
to address specific vehicles and wait for response, and
to embody various means and technical implementations, for instance I[nfra]R[ed] and microwave, rebroadcasting, noise radar with location being coded into the unique identifier, zero road fatalities system including a variety of system elements, inter-vehicle communication, etc.

Moreover, exemplary prior art systems matching the above description are disclosed
in prior art document US 6 370 475 B1 referring to an accident avoidance system comprising lane departure warning,
in prior art document US 6 405 132 B1 referring to an accident avoidance system calculating the collision probability from vehicle positions received by inter-vehicle communication,
in prior art document US 2002/0105423 A1 referring to a reaction advantage anti-collision system and method in which the brake information is extended to other vehicles by means of electronic messages,
in prior art document US 2003/0212567 A1 referring to a witness information service with image capturing and sharing; upon the occurrence of an emergency event, an emergency signal is broadcasted to vehicles within the area to save and transmit an immediate past image history and an immediate future image history,
in the prior art article “CPS-based message broadcast for adaptive inter-vehicle communications” by M. Sun [Proceedings of IEEE Vehicular Technology Conference, fall 2000, volume 6, pages 2685 to 2692; Boston (Mass.)],
in the prior art article “Location aided broadcast in wireless ad hoc networks” by M. Sun, W. Feng, T. H. Lai [Proceedings of IEEE GLOBECOM 2001, pages 2842 to 2846, San Antonio (Tex.)],
in the prior art article “Adaptive Broadcast for Travel and Traffic Information Distribution Based on Inter-Vehicle Communication” by Lars Wischhof, Andre Ebner and Hermann Rohling [Proceedings of IEEE Intelligent Vehicles Symposium 2003, Jun. 9-11, Columbus (Ohio)], and
in the prior art article “Adaptive Layered Data Structure for Inter-Vehicle Communication in Ad-hoc Networks” by Michael B. Lachlan [Eighth International World Congress on Intelligent Transport Systems, September 2001, Sydney].

Apart from that prior art article “A Reachability-Guaranteed Approach for Reducing Broadcast Storms in Mobile Ad Hoc Networks” by Chun-Chuan Yang and Chao-Yu Chen [Proceedings of 56th IEEE Vehicular Technology Conference, fall 2002, volume 2, pages 1036 to 1040] discloses an approach for reducing broadcast storms in mobile ad hoc networks. The approach is based on location awareness meaning that each node in the network has to equip the positioning device, like GPS, and exchanges location information in the hello message with its neighbours.

However, to avoid broadcast storms the node according to the prior art article by Yang and Chen after receiving a message for the first time has to wait a random number of timeslots before rebroadcasting the message. During that time the node monitors whether the node gets the same message also by other nodes. Hereupon the node rebroadcasts the message to all nodes that do not rebroadcast the message.

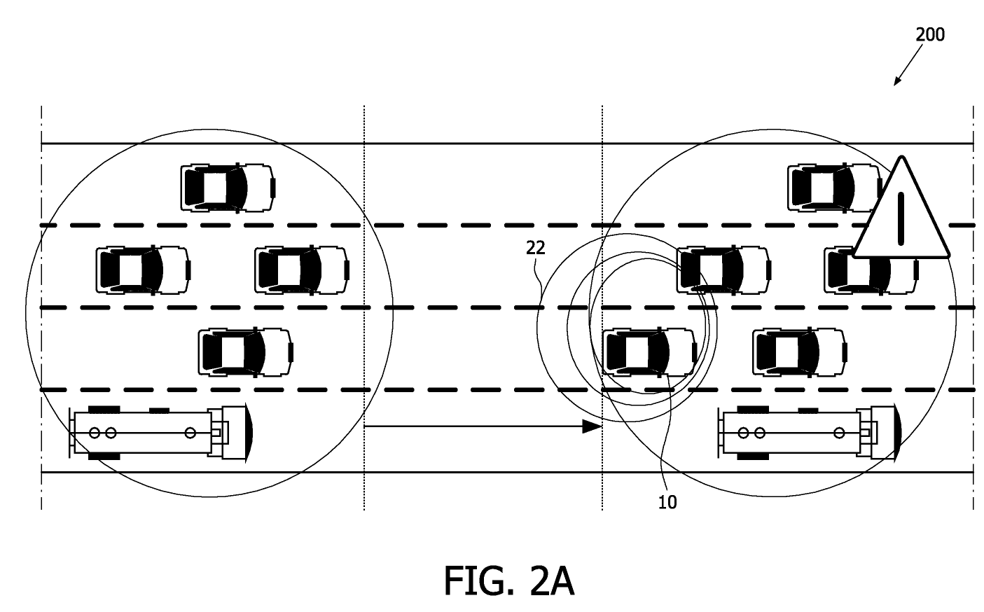

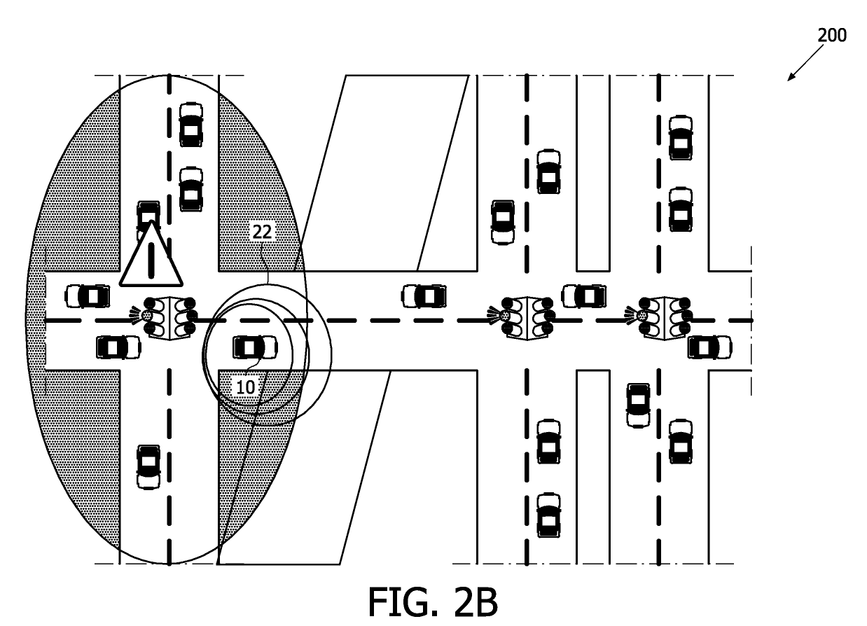

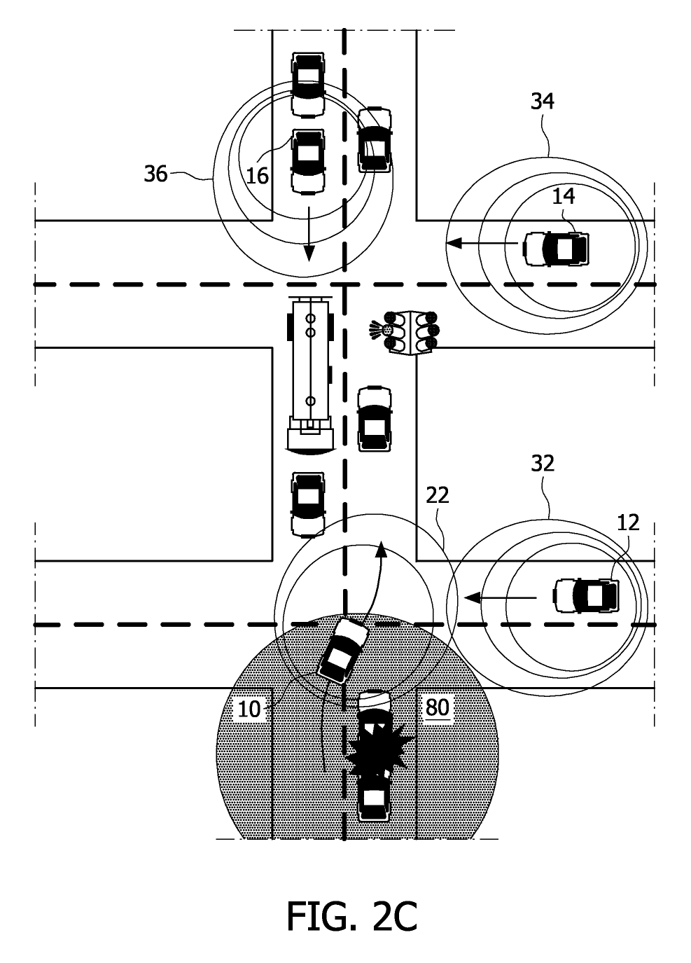

Despite all efforts as described above, the following problems remain:
(i) During market introduction of systems matching the above description the penetration ratio of equipped vehicles is relatively low, leaving a high probability that no receiver of the broadcast message is available. As depicted in FIGS. 2A and 2B the network is fragmented either because of
a short-time dynamic problem, for example a gap, due to variable vehicle speeds (cf. FIG. 2A) or
   a static problem due to specific road topologies, for example due to a long bridge, and/or due to specific city topologies (cf. FIG. 2B).
(ii) Broadcast is a special form of communication where it is unknown how many receivers are available. Therefore the standard acknowledgement methods as defined for example in the W[ireless]L[ocal]A[rea]N[etwork] standard IEEE 802.11 for point-to-point communication are not applicable.
(iii) If each vehicle acknowledges the warning message individually the well-known broadcast storms (cf. prior art article “The Broadcast Storm Problem in Mobile Ad Hoc Network” by S. Y. Ni [Proceedings of IEEE MOBICOM 1999, pages 151 to 162, Seattle (Wash.)] would become an issue for the overall channel throughput.
(iv) The signal quality, for instance the bit error rate, is strongly correlated to the street topology, and areas covered with buildings have severely deteriorated channel conditions compared to roads and highways with line-of-sight conditions. This means that in the ideal case the signal should be emitted using directional antennas along the roads and highways.

This would require geocast routing algorithms (cf. prior art article “Performance evaluation of stored geocast” by C. Maihofer, C. Cseh, W. Franz, and R. Eberhardt [Proceedings of IEEE 58th Vehicular Technology Conference, fall 2003, Oct. 6 to 9, volume 5, issue 4, pages 2901 to 2905]) or even interaction of directed antenna beams with the navigation data derived from a digital map.

Obviously this increases system complexity and cost and is directly related to the accuracy and availability of digital data.

Starting from the disadvantages and shortcomings as described above and taking the prior art as discussed into account, an object of the present invention is to further develop a communication device of the kind as described in the technical field and a method of the kind as described in the technical field in such way that the amount of broadcast messages in inter-node communication, in particular in inter-vehicle communication, is reduced.

The object of the present invention is achieved by a communication device comprising the features of claim 1 as well as by a method comprising the features of claim 7. Advantageous embodiments and expedient improvements of the present invention are disclosed in the respective dependent claims.

By the present invention the amount of broadcast messages is kept to a minimum, increasing the overall performance and availability of the shared medium while optimizing the reachability of at least one message, in particular at least one warning message, for at least one other node or for at least one neighbouring node. It will be appreciated by a person skilled in the art that apart from the moving direction of the node and from the rough position of the neighbouring node, no other digital map information is required to implement the present system as well as the present device.

The present invention is principally based on the idea to ensure reliable and scalable broadcast in mobile ad hoc networks, in particular in the context of inter-vehicular communication. In this context, “reliable” is not necessarily meant to be hundred percent deterministic but rather refers to confirmed delivery of the message, in particular of the warning message being disseminated from the node to the neighbouring node, in particular to a variety of nodes in the close environment, and potentially to infrastructure elements.

In view of scenarios where message reception cannot be guaranteed, it is obvious that at least one originator of the message needs to re-broadcast the message until some form of delivery confirmation is received. According to a preferred embodiment of the present invention the communication device comprises at least one control unit, in particular at least one message dissemination mechanism, being reliable in the sense that relevant nodes, i.e. neighbouring nodes being in the zone of relevance, provide a feedback to the message originator or message sender such that it can stop the, in particularly periodic, broadcast of the message.

The present invention is not depending on network addresses but ensures, in particular by means of at least one message handling algorithm that the message reaches every node in the zone of relevance, in particular in the so-called “range to live”, and that the message stays alive for a certain time of relevance, in particular for the so-called “time to live”.

According to a preferred embodiment of the present invention an algorithm is provided ensuring that at least one of the nodes moving in any direction ensures that the message is rebroadcasted; this node can be called the owner of the direction.

To this aim, according to a preferred embodiment of the present invention, a message dissemination mechanism is defined, introducing an acknowledge(ment) field in each message wherein the acknowledge(ment) field is relating to the direction the message is being taken to, for example to the propagation direction of the message. To reduce redundant messaging the information of the acknowledge(ment) field can be used to determine whether the node should, in particularly periodically, broadcast the message or not.

The owner of the direction marks each broadcasted message with an acknowledge(ment) bit for the owned direction. Moreover, according to a preferred embodiment of the present invention the nodes, in particular the neighbouring nodes, monitor and average their moving direction and can become owner for a direction if they discover that the acknowledge(ment) bit for their moving direction is not set. If nodes change their moving direction they can release the ownership and it is ensured that another node can become the new owner of that direction.

In order to reduce the number of road fatalities as inter alia demanded by the European Commission e-safety initiative, the present invention proposes a communication system comprising at least two communication devices as described above, wherein
at least one of the communication devices is assigned to the reference node or respective node, in particular to the considered car or first transport node, and
at least one of the communication devices is assigned to the neighbouring node, in particular to the neighbouring car or second transport node.

The communication system can be implemented as a road warning system where vehicles equipped with sensors or dedicated infrastructure sensors determine potential hazards like reduced friction, unexpected road obstacles, collisions impacting safety of following traffic, or a hidden rear end of a traffic jam. Messages, in particular these warning messages, can be propagated using any wireless communication method, for example the well-known WLAN standard IEEE 802.11 across the neighbourhood in a way that all nodes, in particular all vehicles, potentially destined for the zone of relevance are warned in time. The message is broadcasted to ensure low latency and to avoid the overhead of addressing individual nodes, in particular of addressing individual vehicles.

According to a particularly inventive refinement, the present invention can be based on an omni-directional geocast algorithm for dissemination of car-to-car messages in low penetration scenarios or with large inter-vehicle gaps.

The present invention is generally applicable for confirmed delivery of messages in node environments without using digital maps. It allows omni-directional flooding also in city scenarios with a minimum number of acknowledge(ment)s. Advantageously, a number of acknowledge(ment)s are collected before the node, in particular the relay node or the owner of the direction node or the transport node, stops re-broadcasting.

Finally, the present invention relates to the use of at least one communication device as described above and/or of at least one communication system as described above and/or of the method as described above for at least one wireless ad hoc network, in particular for at least one sensor network or for wireless local danger warning, for example for car-to-car communication, wherein sensor-equipped cars interact cooperatively and distribute for example warning messages for real time traffic update, especially for accident-free driving, for instance
in order to avoid collisions during lane change or merge manoeuvres and
for reporting invisible obstacles, for example obscured or shadowed objects.

In an alternative scenario, cars may be warned by means of the present invention when entering an intersection that should be kept free for a fire truck.

As already discussed above, there are several options to embody as well as to improve the teaching of the present invention in an advantageous manner. To this aim, reference is made to the claims respectively dependent on claim 1, on claim 5 and on claim 7; further improvements, features and advantages of the present invention are explained below in more detail with reference to a preferred embodiment by way of example and to the accompanying drawings where

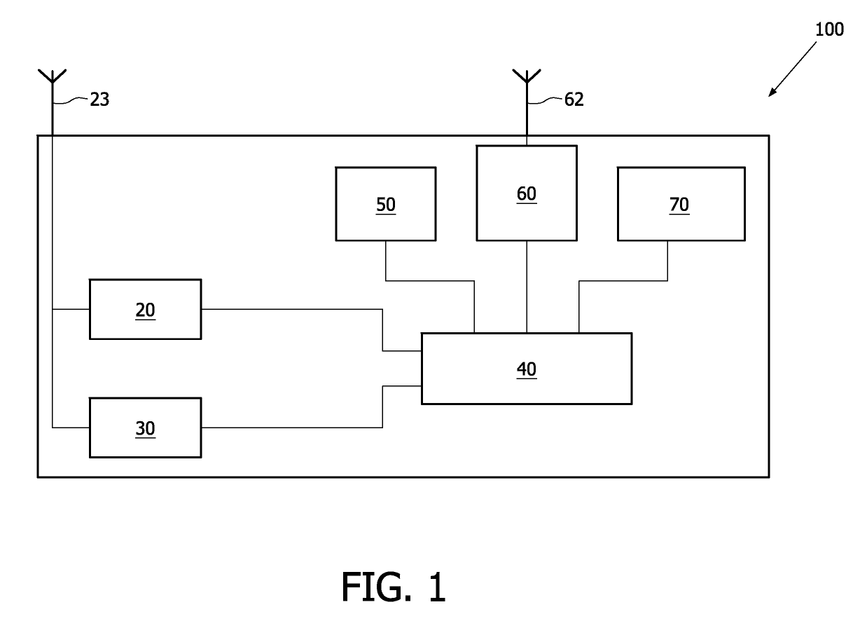

FIG. 1 schematically shows a block diagram of an embodiment of a communication device according to the present invention, working according to the method of the present invention;

FIG. 2A schematically shows a first embodiment of a communication system according to the present invention wherein an application of inter-node (=inter-vehicular) communication in case of a peril ahead is exemplified;

FIG. 2B schematically shows a second embodiment of a communication system according to the present invention wherein an application of inter-node (=inter-vehicular) communication in case of a peril at an intersection is exemplified;

FIG. 2C schematically shows a third embodiment of a communication system according to the present invention wherein an application of inter-node (=inter-vehicular) communication in case of a peril at an intersection is exemplified; and

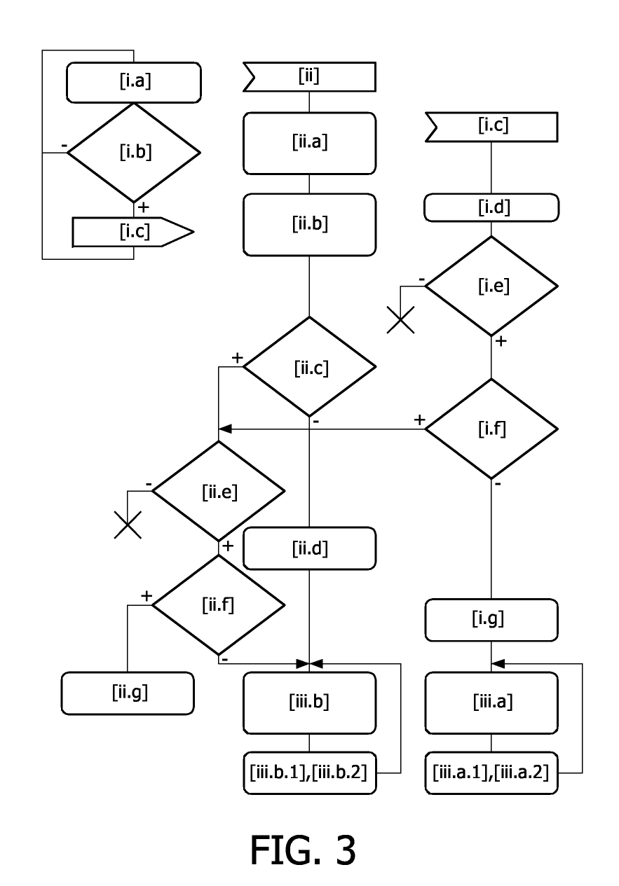

FIG. 3 schematically shows a flow-chart of an algorithm referring to the method according to the present invention.

The same reference numerals are used for corresponding parts in FIGS. 1 to 3.

FIG. 1 depicts a communication device 100 for communication between and among mobile nodes, namely between and among vehicles 10, 12, 14, 16 (cf. FIGS. 2A, 2B, 2C).

The communication device 100 comprises
a transmission unit 20 for communicating, namely for broadcasting and for rebroadcasting, a message 22, as well as
a receiver unit 30 for sensing an arriving messages 32, 34, 36 being communicated by the neighbouring vehicles 12, 14, 16.

The transmission unit 20 and the receiver unit 30 are connected
to a receiving/transmitting antenna 23 and
to a controller unit 40, namely to a message dissemination control box, for controlling the sending behaviour of the respective vehicle 10, 12, 14, 16, namely for deciding whether the respective vehicle 10, 12, 14, 16 rebroadcasts the message 32, 34, 36 or not, by processing the arriving message 32, 34, 36, in particular by processing an acknowledgement array of the arriving message 32, 34, 36.

Further, the controller unit 40 is connected
to a localisation unit 60, namely to a G[lobal]P[ositioning]S[ystem] unit, being assigned to a G[lobal]P[ositioning]S[ystem] antenna 62, for determining and for monitoring the moving direction of the respective vehicle 10, 12, 14, 16,
to a danger sensing unit 50 being designed for sensing an object or a subject being relevant, in particular dangerous, for one or more of the respective vehicles 10, 12, 14, 16, and
to a receiving unit 70, namely to a display unit, being designed for receiving the arriving message 32, 34, 36 and the subject or object being sensed by the danger sensing unit 50.

In FIGS. 2A, 2B, 2C an embodiment of a communication system 200 according to the present invention is depicted. Messages 22, 32, 34, 36 are (re)broadcasted to the environment by vehicles 10, 12, 14, 16, each vehicle 10, 12, 14, 16 comprising the communication device 100 as described above.

Each message 22, 32, 34, 36 comprises the acknowledgement array or acknowledgement field specifying received confirmations, so-called acknowledge(ment)s per driving direction. The communication system 200 ensures that the vehicle 10 rebroadcasts the message 22
until the message 22 is disseminated in all directions of the environment of the zone 80 of relevance (cf. FIG. 2C) and/or
until a specified range to live, for example three kilometres from the zone 80 of relevance, is expired, and/or
until a specified time to live, for example thirty minutes, is expired.

The vehicles 10, 12, 14, 16 can inspect the acknowledgement array or acknowledgement field of the message 22, 32, 34, 36 to discover the directions in which the message 22, 32, 34, 36 is currently being distributed. Thereupon, the vehicles 10, 12, 14, 16 can take over the responsibility for the transport of the message 22, 32, 34, 36 into a certain direction (cf. FIG. 2C) and indicate this by setting the corresponding acknowledgement bit of the acknowledgement array of the message 22, 32, 34, 36 to one.

The vehicles 10, 12, 14, 16 taking over this responsibility and (re)broadcasting the message 22, 32, 34, 36 are called transport nodes. All other vehicles or nodes are not required to (re)broadcast, thereby reducing the network load significantly. Since the driving direction is subject to the road curvature the driving direction is averaged over time. If this averaged driving direction changes, the transport node 10, 12, 14, 16 tries to hand over the responsibility for transport of the message 22, 32, 34, 36 in the former direction to another vehicle.

FIG. 2C depicts the situation of a traffic accident with four vehicles 10, 12, 14, 16 which are equipped with vehicle-to-vehicle communication facility with a specific communication range. It is obvious that the vehicle 10 having detected the accident and trying to warn the environment has to rebroadcast the message 22 for a number of times because otherwise their would be no recipient and the incident report would get lost.

The omni-directional confirmed delivery algorithm demands that the vehicle 10 (re)broadcasts the warning message 22 indicating the geographical coordinates and the diameter of the zone 80 of relevance together with a field of directional acknowledge(ment)s, where the current direction is set to one; this can be taken from the following table where the layout of the message is depicted:

| source | driving | time to | range | zone of relevance, | directional ACK | | | | event |
|---|---|---|---|---|---|---|---|---|---|
| ID | direction | live | to live | coordinates and size | N | E | S | W | code |

Also required is a unique source or message identifier (-->field “source ID” in the message layout) to distinguish messages 22, 32, 34, 36 from different sources. Rebroadcasting a message 22, 32, 34, 36 means that no field of the message must be changed except the acknowledgement field “directional ACK”.

Accordingly, the above table of the layout of the messages 22, 32, 34, 36 comprises information regarding
the unique source or message identifier (-->field “source ID”),
the moving direction of the vehicles 10, 12, 14, 16 by which the respective message 22, 32, 34, 36 is transmitted (-->field “driving direction”),
the time of relevance (-->field “time to live”),
the localisation, namely the geographical coordinates and the dimension or size of the local area (-->field “range to live”),
the localisation, namely the geographical coordinates and the dimension or size of the zone 80 of relevance (-->field “zone of relevance, coordinates and size”),
the acknowledgement array (-->field “directional ACK” with possible entries “N[orth]”, “E[ast]”, “S[outh]”, “W[est]”), and
the event code (-->field “event code”).

In case the node 10 has been driving north for the last period of time, i.e. the average driving direction is north, the node 10 will generate the message 22 with the field “directional ACK: N[orth]” set to “1”. On its route the vehicle 10 will come across the vehicle 16 driving in the opposite direction than the vehicle 10 whereupon the vehicle 16 will receive the message 22 with the field “directional ACK: N[orth]=1”. In order to determine which of the four directional acknowledge(ment) bits to set, it is necessary to verify the following conditions after receiving an arriving message 22, 32, 34, 36 (cf. step [ii] in FIG. 3):
[ii.a] determine if entering the zone 80 of relevance, taking into account the received coordinates from the incident and the actual driving direction; in the example, the vehicles 14, 16 are approaching while the vehicle 10 is departing from the zone 80 of relevance;
[i.a] check the average driving direction; depending on the desired resolution this direction is one of N[orth], E[ast], S[outh], W[est] but this can be more fine grained if more bits in the ACK[nowledge(ment)] field are provided;
[ii.d] if the ACK[nowledge(ment)] bit value for the actual driving direction is still “0”, the vehicle will take ownership of this direction and start re-broadcasting; in the example of FIG. 2C, the vehicle 16 will take ownership of the south direction and rebroadcast with ACK(N[orth]=1) and ACK(S[outh]=1);
[i.g] the driving time in this direction is monitored, and the ownership of ACK for this direction may be released if the average driving time in this direction falls below a certain threshold; for example, the vehicle 12 may take ownership for W[est] direction but may turn S[outh] at the junction;
[iii.a] after some time, the vehicle 12 will release ownership for W[est] and rebroadcast with ACK(W[est]=0);
[iii.b.1, iii.b.2; iii.a.1, iii.a.2] calculate if time to live and range to live is valid; this can be achieved by a globally synchronized time base, which is generally available via G[lobal]P[ositioning]S[ystem] or via broadcasted atomic clock; the range to live is checked by computing the actual geographic distance from the zone 80 of relevance coordinates given in the received message;
[iii.a, iii.b] as long as some ACK[nowledge(ment)] bits are still set to “0”, i.e. not all directions have been acknowledged yet the vehicles will continue to rebroadcast the message until the range to live or the time to live has expired.

If in the example depicted in FIG. 2C the vehicle 10 meets the vehicle 12 first, the vehicle 10 hands over the initial message with ACK(N[orth]=1). From that encounter onwards, the vehicle 10 and the vehicle 12 both will broadcast with ACK(N[orth]=1, W[est]=1). The vehicle 14 recognizes that ACK(W[est]=1) is already set and does not rebroadcast. Then the vehicle 10 meets the vehicle 16 and both will continue broadcasting with ACK(N[orth]=1, S[outh]=1, W[est]=1). Leaving the depicted scene, the vehicles 10, 12, 16 will rebroadcast until the range to live as well as the time to live expire assuming that the vehicles 10, 12, 16 do not change their respective direction.

In the following, some potential enhancements of the communication device 100 working according to the method of the present invention are disclosed:
The subdivision of directions can be more fine grained, specifying N[orth-]E[ast] direction, S[outh-]E[ast] direction etc.
Instead of collecting only one acknowledge(ment) per direction, the reception of more than one acknowledge(ment) per direction would increase the probability that the message 22, 32, 34, 36 has been omni-directionally spread.
The information that a vehicle is approaching the zone 80 of relevance can be used to install two transport nodes running in the same direction where one transport node is approaching the zone 80 of relevance while the other is departing from the zone 80 of relevance.

The method according to FIG. 3 assumes that multiple messages with identical message ID[entifier]s are received through rebroadcasting.

More than one vehicle can be owner of a direction, this only increasing the reachability.

For each message ID, the status of ownership for directions, the range to live, the time to live, etc. may be stored separately; after reception of the warning message the status of the message is loaded from the memory (cf. step [ii.b] in FIG. 3).

After the message is loaded from the memory (cf. step [ii.b] in FIG. 3) it is determined whether the received acknowledgement is set in the average driving direction of the vehicle which received the message (cf. step [ii.c] in FIG. 3). The direction where the vehicle is driving for an average duration of time is the driving direction of the vehicle. The average is calculated by means of at least one timer based for example on compass information.

It is monitored if there is a change in the average direction (cf. step [i.b] in FIG. 3). Every time the average direction is changed (cf. step [i.c] in FIG. 3) it is checked whether a message has to be sent, and the ownership status is inquired (cf. step [i.d] in FIG. 3).

The step [i.d] of inquiring the ownership status means to consult the following “direction ownership” table:

| message ID | direction | desire to release |
|---|---|---|
| . . . | | |
| 12345 | E[ast] | +(=yes) |
| 12346 | W[est] | −(=no) |
| . . . | | |

Accordingly, this direction ownership table comprises information regarding
at least one message identifier (-->array “message ID”),
the direction of which the ownership is taken over by the vehicle (-->array “direction”), and
if the vehicle desires to release the direction of which it has taken over the ownership or not (-->array “desire to release”).

In this context,
step [i.g] of release ownership means entering “yes” in the array “desire to release” of the direction ownership table;
step [ii.d] of taking over ownership for the own direction means adding an entry to the direction ownership table;
if in step [ii.e] it is decided that the ownership should be resumed, then it is entered “no” in the array “desire to release” of the direction ownership table;
upon step [i.d] it is determined whether the respective vehicle holds the ownership for any direction area or not (cf. step [i.e] in FIG. 3) wherein in case of step [i.e] being true (=“+” in FIG. 3) it is determined whether the ownership of the direction area is resumed by the respective vehicle or not (cf. step [i.f] in FIG. 3); depending on the ownership status, the vehicle may want to release this ownership (cf. step [i.g] in FIG. 3);
in case of step [ii.c] being true ( “+” in FIG. 3) it is determined whether the respective vehicle holds the ownership for the direction area relating to the moving direction of the respective node or not (cf. step [ii.e] in FIG. 3) wherein
in case of step [ii.e] being true (=“+” in FIG. 3) it is determined whether the respective vehicle wishes to release the ownership of the direction area relating to the moving direction of the respective vehicle or not (cf. step [ii.f] in FIG. 3),
in case of step [ii.f] being true (=“+” in FIG. 3) the respective vehicle deletes the ownership for the direction area relating to the moving direction of the respective vehicle (cf. step [ii.g] in FIG. 3), or
in case of step [ii.f] being not true (=“−” in FIG. 3) the respective vehicle goes to step [iii.b];
the step [ii.g] of deleting the ownership means clearing the entry in the direction ownership table;
after the time to live has expired or the range to live has expired the table entry is cleared.

### LIST OF REFERENCE NUMERALS

100 communication device
10 reference node or respective node, in particular first transport node, for example first vehicle
12 first neighbouring node, in particular second transport node, for example second vehicle
14 second neighbouring node, in particular third transport node, for example third vehicle
16 third neighbouring node, in particular fourth transport node, for example fourth vehicle
20 transmission unit, in particular sender block
22 message communicated to neighbouring nodes 12, 14, 16
23 transceiver antenna, assigned to transmission unit 20 as well as to receiver unit 30
30 receiver unit, in particular receptor block
32 arriving message communicated by first neighbouring node 12
34 arriving message communicated by second neighbouring node 14
36 arriving message communicated by third neighbouring node 16
40 controller unit, in particular message dissemination control box
50 danger sensing unit
60 localisation unit, in particular positioning device, for example G[lobal]P[ositioning] S[ystem] unit
62 localisation antenna, in particular G[lobal]P[ositioning]S[ystem] antenna, assigned to localisation unit 60
70 recording unit, in particular display unit and/or loudspeaker unit
80 zone of relevance
200 communication system

1. A communication device (100) for communication between and among mobile nodes (10, 12, 14, 16), in particular between and among vehicles, comprising
at least one transmission unit (20), in particular at least one sender block, for communicating, in particular broadcasting and/or rebroadcasting, at least one message (22),
at least one receiver unit (30), in particular at least one receptor block, for sensing at least one arriving message (32, 34, 36) being communicated by at least one neighbouring node (12, 14, 16), and
at least one localisation unit (60), in particular at least one positioning device, for example at least one G[lobal]P[ositioning]S[ystem] unit, for determining and/or for monitoring the moving direction, in particular the averaged moving direction, and/or the current position of the respective node (10, 12, 14, 16), characterized in that each message (22; 32, 34, 36) being communicated between and among the nodes (10, 12, 14, 16)
is assigned
to at least one message type and/or message subject, in particular by means of at least one event code, and
to at least one direction area, for example north, east, south or west, relating to the moving direction of the node (10, 12, 14, 16) by which the respective message (22; 32, 34, 36) is transmitted, the moving direction being determined and/or monitored by the localisation unit (60) of the respective node (10, 12, 14, 16), and
comprises at least one acknowledgement array, in particular at least one acknowledgement field, comprising at least one information regarding to the respective direction area of the, in particular of all, messages (22; 32, 34, 36)
being assigned to the same message type and/or message subject and being communicated
within a certain local area around at least one zone (80) of relevance, in particular within a predetermined range to live, and/or
within a certain time of relevance, in particular within a predetermined time to live.

2. The communication device according to claim 1, characterized in that the layout of the message (22; 32, 34, 36) comprises information regarding
at least one unique source and/or
at least one message identifying code and/or
the moving direction of the node (10, 12, 14, 16) by which the respective message (22; 32, 34, 36) is transmitted, and/or
the time of relevance, and/or
the localisation, in particular the geographical coordinates and/or the dimension or size, of the local area, and/or
the localisation, in particular the geographical coordinates and/or the dimension or size, of the zone (80) of relevance, and/or
the acknowledgement array, and/or
the message type and/or message subject.

3. The communication device according to claim 1, characterized in that each node (10, 12, 14, 16) comprises at least one controller unit (40), in particular at least one message dissemination control box, for controlling the sending behaviour of the respective node (10, 12, 14, 16), in particular for deciding whether the respective node (10, 12, 14, 16) rebroadcasts the message (32, 34, 36) or not, by processing at least part of the arriving message (32, 34, 36), in particular by processing the acknowledgement field.

4. The communication device according to claim 3, characterized in that the controller unit (40)
comprises at least one list or table wherein the respective message (22; 32, 34, 36) is stored, in particular according to its layout and/or
is connected
with at least one danger sensing unit (50) being designed for sensing at least one object or at least one subject being relevant, in particular dangerous, for the respective node (10, 12, 14, 16), and/or
with at least one recording unit (70), in particular at least one display unit and/or at least one loudspeaker unit, being designed for recording the arriving message (32, 34, 36) and/or the object or subject being sensed by the danger sensing unit (50).

5. A communication system (200) for communication between and among mobile nodes (10, 12, 14, 16), in particular between and among vehicles, characterized by at least two communication devices (100) according to claim 1 wherein
at least one of the communication devices (100) is assigned to the reference node or respective node (10), in particular to the considered car, and
at least one of the communication devices (100) is assigned to the neighbouring node (12, 14, 16), in particular to the neighbouring car.

6. The communication system according to claim 5, characterized in,
that at least one of the nodes (10, 12, 14, 16) takes ownership for the direction area relating to the moving direction of the node (10, 12, 14, 16), in particular ensures that the message (22; 32, 34, 36) is rebroadcasted in the direction area relating to the moving direction of the node (10, 12, 14, 16), and/or
that the message (22; 32, 34, 36) is rebroadcasted until the message (22; 32, 34, 36) is disseminated in all direction areas of the local area of the zone (80) of relevance.

7. A method for communication between and among mobile nodes (10, 12, 14, 16), in particular between and among vehicles, with each node (10, 12, 14, 16) being designed for
[i] determining and/or monitoring the moving direction and/or the current position of the respective node (10, 12, 14, 16), in particular
[i.a] calculating the average moving direction and
[i.b] determining and/or monitoring if there is a change in the average moving direction of the respective node (10, 12, 14, 16), and
[ii] receiving at least one arriving message (32, 34, 36) being communicated, in particular broadcasted and/or rebroadcasted, by at least one neighbouring node (12, 14, 16), and
[iii] communicating, in particular broadcasting and/or rebroadcasting, at least one message (22), wherein each message (22; 32, 34, 36) being communicated between and among the nodes (10, 12, 14, 16)
is assigned
to at least one message type and/or message subject, in particular by means of at least one event code, and
to at least one direction area, for example north, east, south or west, relating to the moving direction of the node (10, 12, 14, 16) by which the respective message (22; 32, 34, 36) is transmitted and
comprises at least one acknowledgement array, in particular at least one acknowledgement field, comprising at least one information regarding to the respective direction area of the, in particular of all, messages (22; 32, 34, 36)
being assigned to the same message type and/or message subject and
being communicated
within a certain local area around at least one zone (80) of relevance, in particular within a predetermined range to live, and/or
within a certain time of relevance, in particular within a predetermined time to live.

8. The method according to claim 7, characterized by
deciding whether the respective node (10, 12, 14, 16) rebroadcasts the message (32, 34, 36) or not, by processing at least part of the arriving message (32, 34, 36), in particular by processing the acknowledgement field, and/or
rebroadcasting the message (22; 32, 34, 36) until the message (22; 32, 34, 36) is disseminated in all direction areas of the local area of the zone (80) of relevance.

9. The method according to claim 7%)ru&<characterized in that
[ii.d] at least one of the nodes (10, 12, 14, 16) takes ownership for the direction area relating to the moving direction of the node (10, 12, 14, 16), in particular ensures that the message is rebroadcasted in the direction area relating to the moving direction of the node (10, 12, 14, 16),
in particular after sensing at least one object or at least one subject being relevant, in particular dangerous, for the respective node (10, 12, 14, 16), and/or
in particular after receiving the arriving message (32, 34, 36).

10. The method according to 7 , characterized in that
[i.c] in case of direction change
[i.d] at least one direction ownership list or direction ownership table comprising information regarding to
at least one unique source and/or
at least one message identifying code and/or
the moving direction of the node (10, 12, 14, 16) by which the respective message (22; 32, 34, 36) is transmitted, and/or
the desire to release the message (22; 32, 34, 36) is inquired, and/or
[i.e] it is determined whether the respective node (10, 12, 14, 16) holds the ownership for any direction area or not,
[i.f] wherein in case of step [i.e] being true it is determined whether the ownership of the direction area is resumed by the respective node (10, 12, 14, 16) or not,
[i.g] wherein in case of step [i.f] being not true, the ownership of the direction area is released, and/or
[iii.a] the message (22; 32, 34, 36) is rebroadcasted
[iii.a.1] until the certain local area around at the zone (80) of relevance is left and/or
[iii.a.2] until the certain time of relevance is expired, in particular the message (22; 32, 34, 36) comprising the information that the direction area released in step [i.g] is not owned by at least one of the nodes (10, 12, 14, 16).

11. The method according to claim 7, characterized in that upon step [ii] of receiving at least one arriving message (32, 34, 36)
[ii.a] it is determined whether the respective node (10, 12, 14, 16) enters the zone (80) of relevance, in particular by processing at least part of the received arriving message (32, 34, 36) and by taking into account the determined and/or monitored moving direction, and in case of the respective node (10, 12, 14, 16) entering the zone (80) of relevance, the driver of the respective node (10, 12, 14, 16) is alerted, and/or
[ii.b] information of the arriving message (32, 34, 36), in particular
at least one unique source and/or
at least one message identifier and/or
the moving direction of the node (10, 12, 14, 16) by which the respective message (22; 32, 34, 36) is transmitted, and/or
the time of relevance, and/or
the localisation, in particular the geographical coordinates and/or the dimension or size, of the local area, and/or
the localisation, in particular the geographical coordinates and/or the dimension or size, of the zone (80) of relevance, and/or
the acknowledgement array, and/or
the message type and/or message subject is stored and/or monitored and/or
[ii.c] it is determined whether the ownership for the direction area relating to the moving direction of the respective node (10, 12, 14, 16) has been taken over by at least one of the nodes (10, 12, 14, 16) or not,
[ii.d] wherein in case of step [ii.c] being not true, the ownership for the direction area relating to the moving direction of the respective node (10, 12, 14, 16) is taken over by the respective node (10, 12, 14, 16), and
[iii.b] the message (22; 32, 34, 36) is rebroadcasted
[iii.b.1] until the certain local area around at the zone (80) of relevance is left and/or
[iii.b.2] until the certain time of relevance is expired, in particular the message (22; 32, 34, 36) comprising the information that the direction area the ownership of which is taken over in step [ii.d] is owned by at least one of the nodes (10, 12, 14, 16), and/or
[ii.e] wherein in case of step [ii.c] being true, it is determined whether the respective node (10, 12, 14, 16) holds the ownership for the direction area relating to the moving direction of the respective node (10, 12, 14, 16) or not,
[ii.f] wherein in case of step [ii.e] being true, it is determined whether the respective node (10, 12, 14, 16) wishes to release the ownership of the direction area relating to the moving direction ofthe respective node (10, 12, 14, 16) or not,
[ii.g] wherein in case of step [ii.f] being true, the respective node (10, 12, 14, 16) deletes the ownership for the direction area relating to the moving direction of the respective node (10, 12, 14, 16), or
wherein in case of step [ii.f] being not true, the respective node (10, 12, 14, 16) goes to step [iii.b].

12. Use of at least one communication device (100) according to claim 1 for at least one wireless ad hoc network, in particular for at least one sensor network or for wireless local danger warning, for example for car-to-car communication, wherein sensor-equipped cars interact cooperatively and distribute for example warning messages for real time traffic update, especially for accident-free driving, for instance
in order to avoid collisions during lane change or merge manoeuvres and
for reporting invisible obstacles, for example obscured or shadowed objects.
